(19) United States
(12) Patent Application Publication
(10) Pub. No.: US 2026/0026634 A1
(43) Pub. Date: Jan. 29, 2026

(54) Air mattress with integrated auxiliary panel

(71) Applicant: Pittman Products International, Inc., Placentia, CA (US)

(72) Inventor: James J PITTMAN, Yorba Linda, CA (US)

(73) Assignee: Pittman Products International, Inc., Placentia, CA (US)

(21) Appl. No.: 19/256,592

(22) Filed: Jul. 1, 2025

Related U.S. Application Data
(60) Provisional application No. 63/674,972, filed on Jul. 24, 2024.

(51) Int. Cl. A47C 27/10; A47C 27/08; B60N 3/00

(52) U.S. Cl. CPC A47C 27/10; A47C 27/082; B60N 3/008

(57) ABSTRACT

An inflatable mattress includes a main section and at least one minor section. The main section includes a main section lower wall having main section lower wall edges, a main section upper wall having main section upper wall edges, and at least one main section sidewall connecting between the main section lower wall edges and the main section upper wall edges to form a main section air chamber. The at least one minor section includes a minor section lower wall having minor section lower wall edges connected to a minor section upper wall having minor section upper wall edges to form a minor air chamber. The at least one minor section is connected to the main section by a first pivotable connection between one main section lower wall edge and one minor section lower wall edge, or a second pivotable connection between one main section upper wall edge and one minor section upper wall edge.

### CROSS REFERENCES AND PRIORITIES

This Application claims priority from U.S. Provisional Application No. 63/674,972 filed on 24 Jul. 2024, the teachings of which are incorporated by reference herein in their entirety.

### BACKGROUND

Many vehicles, such as pickup trucks, include a bed area which is frequently utilized for storing and hauling cargo. The typical pickup truck bed includes a substantially planar surface behind the truck's occupant cab. The rear wall of the truck's occupant cab therefor forms a front wall of the pickup truck bed. Frequently, the pickup truck bed will also include opposing side walls extending from the rear of the occupant cab to the rear of the substantially planar surface.

Many pickup truck beds also include a pivotable rear wall known as a tailgate which may be opened and closed via a latch and hinge system to allow access to the pickup truck bed for loading and unloading cargo. Often, the substantially planar surface will also include one or more inwardly and upwardly protruding wheel well sections which interrupt the planar surface.

In recent times, users have been utilizing pickup truck beds as a sleeping area, such as for camping, overlanding, and the like. However, pickup truck beds—due to their rigid (often metal) materials of construction—do not make for a comfortable sleeping surface. Accordingly, attempts have been made to design a portable—often inflatable-mattress adapted to be removably installed into a pickup truck bed.

One such solution is disclosed in U.S. Pat. No. 8,468,624 B2 which describes a multi-purpose air mattress apparatus for use in at least a bed of a vehicle having an opposing pair of inwardly protruding wheel wells. The apparatus comprises, in one embodiment, an inflatable air mattress having a pair of opposing sidewalls, each defining a lateral recess sized for accepting at least a portion of the wheel wells therewithin and further defining recess ledges that selectively sit atop the wheel wells. With the apparatus positioned within the vehicle bed and the wheel wells positioned at least partially within the lateral recesses, the recess ledges in combination with a perimeter ledge cover substantially any exposed portions of the wheel wells, while a set of upper and lower perimeter chambers further maintain a stable structure of the apparatus during use both within a vehicle bed as well as on any other relatively flat surface in otherwise conventional fashion.

Existing inflatable mattresses for pickup truck beds often suffer from certain functional issues specifically related to the wheel well sections of the pickup truck bed. The wheel well sections of the pickup truck typically require the inflatable mattress to include lateral recesses—such as those disclosed in U.S. Pat. No. 8,468,624 B2—which extend around the wheel well. In doing so, the sleeping space on top of the inflatable mattress is drastically reduced by at least the width of the wheel wells. Attempts to incorporate ledges that go over the wheel wells are frequently ineffective—particularly when considering different makes and models of pickup trucks which may have wheel wells of varying heights. For example, a pickup truck having taller wheel wheels than can be accommodated by the combination of lateral recesses and ledges may result in the wheel wells bowing the entire inflatable mattress into a “U” or “V” shape resulting in a curved or angled sleeping surface which lacks comfort.

Other functional issues relate to the length of the truck bed. Certain truck beds may be shorter than the individual seeking to sleep within them. This issue may be alleviated by including a separate section of the inflatable mattress to cover the tailgate section of the pickup truck bed when the tailgate section is opened, thereby extending the length of the inflatable mattress. However, separate sections to cover the tailgate can often become dislodged from the main section that covers the substantially planar surface of the pickup truck bed. On the other hand, simply forming the main section of the inflatable mattress with an increased length to cover the tailgate section may result in complete loss of functionality for those seeking to utilize the inflatable mattress with the tailgate in the closed position as the inflatable mattress will no longer fit within the confines of the pickup truck bed. Moreover, during vehicle operation, the tailgate must be left open with the inflatable mattress inflated thereon—or otherwise the inflatable mattress must be deflated completely to allow the tailgate section to close.

The need exists, therefore, for an improved inflatable mattress for use in a pickup truck bed which adapts for wheel wells of varying dimensions, and which may be selectively adapted to cover a tailgate portion of the pickup truck bed when the tailgate is in an open position.

### SUMMARY

Described herein is an inflatable mattress having a main section and at least one minor section. The main section includes a main section lower wall having main section lower wall edges, a main section upper wall having main section upper wall edges, and at least one main section side wall connecting between the main section lower wall edges and the main section upper wall edges. The main section lower wall, main section upper wall, and at least one main section side wall form a main section air chamber. The at least one minor section includes a minor section lower wall having minor section lower wall edges, and a minor section upper wall having minor section upper wall edges. The minor section lower wall and minor section upper wall are connected to one another and form a minor air chamber. The at least one minor section is connected to the main section by a first pivotable connection between one main section lower wall edge of the main section lower wall edges and one minor section lower wall edge of the minor section lower wall edges, or between one main section upper wall edge of the main section upper wall edges and one minor section upper wall edge of the minor section upper wall edges.

In some embodiments, the inflatable mattress may include a primary electric air pump fluidly connected to the main section air chamber. In certain such embodiments, the at least one main section side wall may include a main sidewall cavity, and the primary electric air pump may be configured to fit within the main sidewall cavity.

In certain embodiments, the primary electric air pump may be fluidly connected to the minor air chamber of at least one minor section. In other embodiments, the inflatable mattress may include a minor electric air pump fluidly connected to the minor air chamber of at least one minor section.

In some embodiments, the main section lower wall edges may include a first main lower end edge, a second main lower end edge opposite the first main lower end edge, a first main lower side edge extending between the first main lower end edge and the second main lower end edge, and a second main lower side edge opposite the first main lower side edge. In certain such embodiments, the main section upper wall edges may include a first main upper end edge, a second main upper end edge opposite the first main upper end edge, a first main upper side edge extending between the first main upper end edge and the second main upper end edge, and a second main upper side edge opposite the first main upper side edge. In some such embodiments, the at least one minor section may include a secondary section having secondary section lower wall edges and secondary section upper wall edges. The secondary section lower wall edges may include a first secondary lower end edge, a second secondary lower end edge opposite the first secondary lower end edge, a first secondary lower side edge extending between the first secondary lower end edge and the second secondary lower end edge, and a second secondary lower side edge opposite the first secondary lower side edge. The secondary section upper wall edges may include a first secondary upper end edge, a second secondary upper end edge opposite the first secondary upper end edge, a first secondary upper side edge extending between the first secondary upper end edge and the second secondary upper end edge, and a second secondary upper side edge opposite the first secondary upper side edge. In some such embodiments, the secondary section may be connected to the main section by the first pivotable connection between the first main lower end edge and the second secondary lower end edge or between the first main upper end edge and the second secondary upper end edge.

In certain embodiments, the secondary section may include at least one secondary section side wall connecting the first secondary section lower wall edges and the first secondary section upper wall edges.

In some embodiments, the first main lower side edge may include a first main lower side edge lateral recess. In certain such embodiments, the second main lower side edge may include a second main lower side edge lateral recess. In some such embodiments, the first main upper side edge may include a first main upper side edge lateral recess. In certain such embodiments, the second main upper side edge may include a second main upper side edge lateral recess. In such embodiments, the at least one minor section may include a tertiary section and or a quaternary section. When present, the tertiary section may include a tertiary section lower wall having tertiary section lower wall edges, and a tertiary section upper wall having tertiary section upper wall edges. The tertiary section lower wall and the tertiary section upper wall may be connected to one another and form a second secondary air chamber. When present, the quaternary section may include a quaternary section lower wall having quaternary section lower wall edges, and a quaternary section upper wall having quaternary section upper wall edges. The quaternary section lower wall and the quaternary section upper wall may be connected to one another and form a third secondary air chamber. In such embodiments, the tertiary section may be connected to the main section by a second pivotable connection between one tertiary section lower wall edged of the tertiary section lower wall edges and at least a portion of the first main upper side edge lateral recess. In such embodiments, the quaternary section may be connected to the main section by a third pivotable connection between one quaternary section lower wall edge of the quaternary section lower wall edges and at least a portion of the second main upper side edge lateral recess.

In certain embodiments, the secondary section may further include a plurality of minor collapsible columns. When present, each minor collapsible column of the plurality of minor collapsible columns may be located between and connected to the secondary section lower wall and the secondary section upper wall.

In some embodiments, the main section may include a main section port. When present, the main section port may be located in the main section side wall with a main valve fluidly connected to the main section port.

In certain embodiments, each minor section of the at least one minor section may include a minor section port. When present, a minor valve may be fluidly connected to the minor section port.

In some embodiments, the main section may include a plurality of main collapsible columns. When present, each main collapsible column of the plurality of main collapsible columns may be located between and connected to the main section lower wall and the main section upper wall.

In certain embodiments, the main section may include a mattress topper. When present, the mattress topper may include a mattress topper lower wall having mattress topper lower wall edges, and a mattress topper upper wall having mattress topper upper wall edges. The mattress topper lower wall and the mattress topper upper wall may be connected to one another and form a mattress topper air chamber.

In some embodiments, the at least one minor section may be configured to rest upon a tailgate of a pickup truck when the tailgate is in an open position. In certain such embodiments, the at least one minor section may be configured to pivot into a stowed position within a bed of the pickup truck to allow the tailgate to be closed without removal or deflation of the inflatable mattress.

In certain embodiments, the at least one minor section may be selectively inflatable and deflatable independent of the main section.

### BRIEF DESCRIPTION OF FIGURES

FIG. 1 is a perspective view of an embodiment of an inflatable mattress including a main section and a plurality of minor sections.

FIG. 2 is an exploded perspective view of an embodiment of an inflatable mattress including a main section and a plurality of minor sections.

FIG. 3 is an exploded perspective view of an embodiment of a main section of an inflatable mattress.

FIG. 4 is a perspective view of an embodiment of a main section of an inflatable mattress.

FIG. 5 is a cut-away perspective view of an embodiment of a main section of an inflatable mattress.

FIG. 6 is an exploded perspective view of an embodiment of a secondary section of an inflatable mattress.

FIG. 7 is a perspective view of an embodiment of a secondary section of an inflatable mattress.

FIG. 8 is a cut-away perspective view of an embodiment of a secondary section of an inflatable mattress.

FIG. 9 is a side view of a main section and a secondary section of an inflatable mattress connected to one another in an extended position within a pickup truck bed.

FIG. 10 is a side view of a main section and a secondary section of an inflatable mattress connected to one another in a partially folded position within a pickup truck bed.

FIG. 11 is an exploded perspective view of a tertiary section and/or a quaternary section of an inflatable mattress.

FIG. 12 is a perspective view of a tertiary section and/or a quaternary section of an inflatable mattress.

FIG. 13 is a side view of main section and a tertiary section and/or a quaternary section of an inflatable mattress connected to one another in an extended position.

FIG. 14 is a side view of a main section and a tertiary section and/or a quaternary section of an inflatable mattress connected to one another in a folded position.

FIG. 15 is an exploded perspective view of a main section of an embodiment of an inflatable mattress including a mattress topper.

FIG. 16 is a perspective view of a main section of an embodiment of an inflatable mattress including a mattress topper.

FIG. 17 is a perspective view of an embodiment of an inflatable mattress for installation into the bed of a pickup truck.

FIG. 18 is a perspective view of an embodiment of an inflatable mattress installed into the bed of a pickup truck.

### DETAILED DESCRIPTION

Disclosed herein is an inflatable mattress. As described herein and, the following numbers refer to the following structures as noted in the Figures.
10 refers to an inflatable mattress.
50 refers to a pickup truck.
51 refers to a pickup truck bed.
52 refers to a wheel well.
53 refers to a tailgate.
100 refers to a main section.
110 refers to a main section lower wall.
111 refers to a first main lower end edge.
112 refers to a second main lower end edge.
113 refers to a first main lower side edge.
114 refers to a second main lower side edge.
115 refers to a first main lower side edge lateral recess.
116 refers to a second main lower side edge lateral recess.
120 refers to a main section upper wall.
121 refers to a first main upper end edge.
122 refers to a second main upper end edge.
123 refers to a first main upper side edge.
124 refers to a second main upper side edge.
125 refers to a first main upper side edge lateral recess.
126 refers to a second main upper side edge lateral recess.
130 refers to a main section side wall.
135 refers to a main side wall cavity.
140 refers to a main section port.
141 refers to a main valve.
150 refers to a main section air chamber.
160 refers to a main collapsible column.
200 refers to a minor section.
201 refers to a secondary section.
210 refers to a secondary section lower wall.
211 refers to a first secondary lower end edge.
212 refers to a second secondary lower end edge.
213 refers to a first secondary lower side edge.
214 refers to a second secondary lower side edge.
220 refers to a secondary section upper wall.
221 refers to a first secondary upper end edge.
222 refers to a second secondary upper end edge.
223 refers to a first secondary upper side edge.
224 refers to a second secondary upper side edge.
230 refers to a secondary section side wall.
240 refers to a minor section port.
241 refers to a minor valve.
250 refers to a secondary air chamber.
260 refers to a tertiary section.
261 refers to a tertiary section lower wall.
262 refers to a tertiary section upper wall.
263 refers to a tertiary air chamber.
270 refers to a quaternary section.
271 refers to a quaternary section lower wall.
272 refers to a quaternary section upper wall.
273 refers to a quaternary air chamber.
280 refers to a minor collapsible column.
300 refers to a primary electric air pump.
310 refers to a minor electric air pump.
400 refers to a mattress topper.
410 refers to a mattress topper lower wall.
420 refers to a mattress topper upper wall.
450 refers to a mattress topper air chamber.

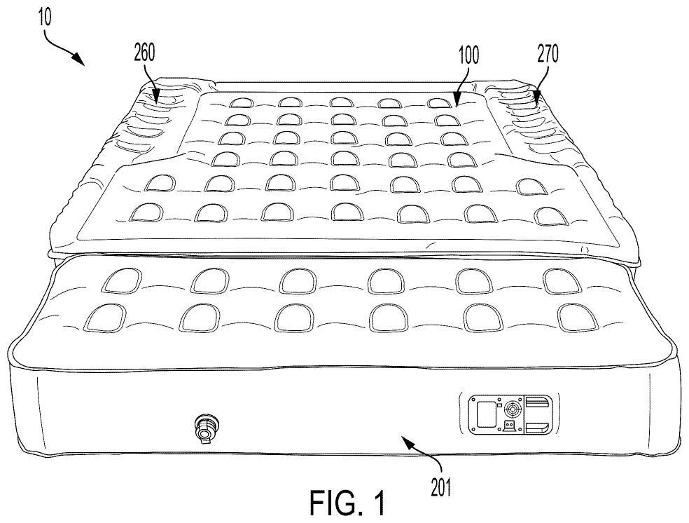

FIG. 1 illustrates an embodiment of an inflatable mattress (10). As shown in FIG. 1, the embodiment of an inflatable mattress includes a main section (100) and at least one minor section (200). While in FIG. 1, the inflatable mattress includes a secondary section (201), a tertiary section (260), and a quaternary section (270), other embodiments may exist. For example, one embodiment of the inflatable mattress may include only the secondary section. Another embodiment of the inflatable mattress may include only the tertiary section. Still another embodiment of the inflatable mattress may include only the quaternary section. Yet another embodiment of the inflatable mattress may include both the tertiary section and the quaternary section.

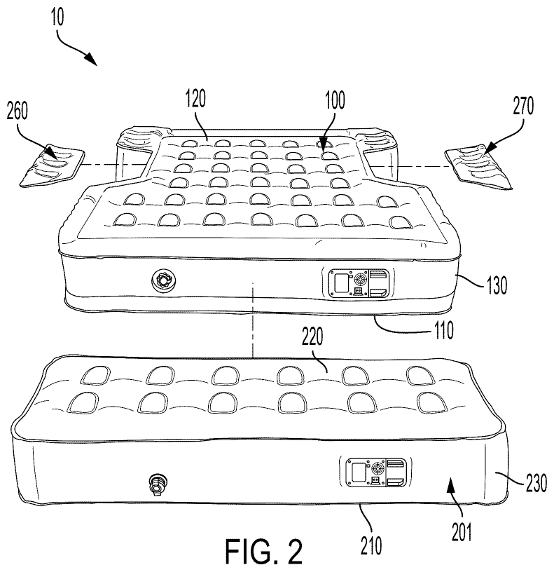

FIG. 2 illustrates a partially exploded view of an embodiment of an inflatable mattress (10) similar to the embodiment shown in FIG. 1. As shown in FIG. 2, the main section (100) may include a main section lower wall (110), a main section upper wall (120), and at least one main section side wall (130). As further shown in FIG. 2, the at least one minor section (200) may include a secondary section (201), a tertiary section (260), and/or a quaternary section (270). Each minor section will include at least a minor section lower wall (in FIG. 2, shown as a secondary section lower wall (210)) and a minor section upper wall (in FIG. 2, shown as a secondary section upper wall (220)). Certain minor sections, such as the secondary section (201) shown in FIG. 2, may also include a secondary section side wall (230).

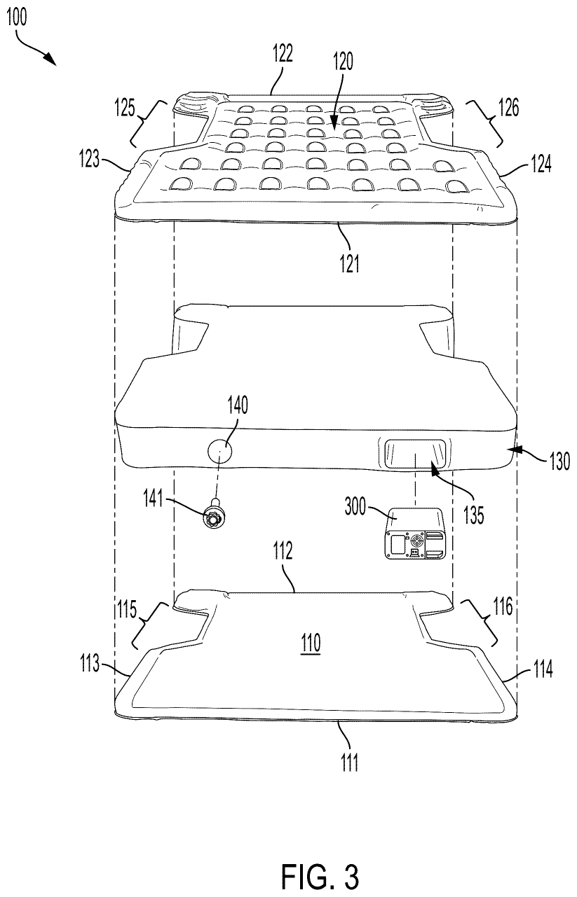

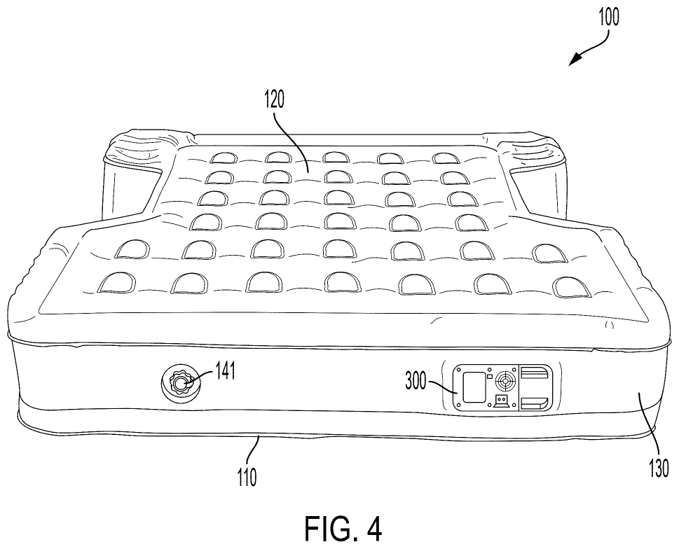

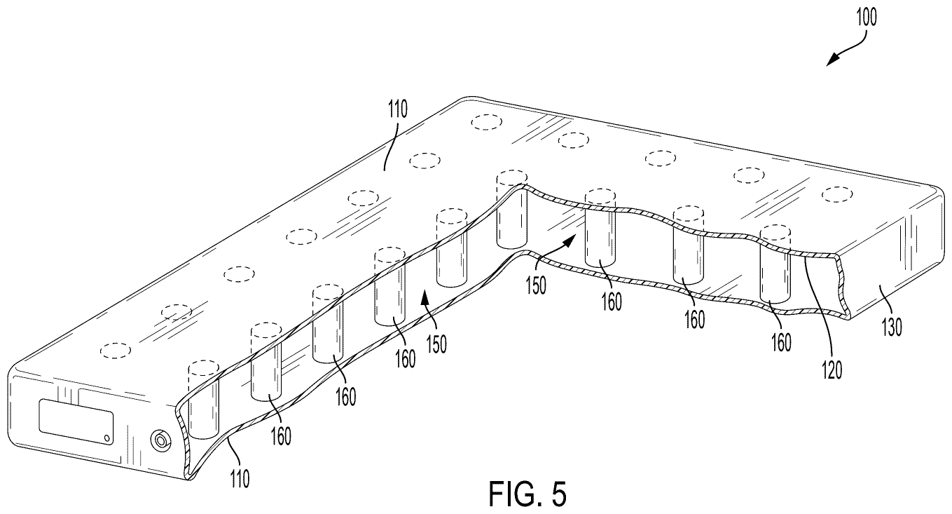

FIG. 3 through FIG. 5 illustrate various views of an embodiment of a main section (100) of an inflatable mattress ((10) as shown in FIG. 1). FIG. 3 showing the main section in exploded form. FIG. 4 showing the main section in assembled form. FIG. 5 showing a cut away view of the main section.

As shown in FIG. 3, the main section lower wall (110) may include at least a first main lower end edge (111) and a second main lower end edge (112) opposite the first main lower end edge. Extending between opposing end points of the first main lower end edge and the second main lower end edge may be a first main lower side edge (113). Opposite the first main lower side edge may be a second main lower side edge (114). This configuration gives the main section lower wall a substantially parallelogram shape.

FIG. 3 further illustrates the main section upper wall (120) which may include at least a first main upper end edge (121) and a second main upper end edge (122) opposite the first main upper end edge. Extending between opposing end points of the first main upper end edge and the second main upper end edge may be a first main upper side edge (123). Opposite the first main upper side edge may be a second main upper side edge (124). This configuration gives the main section upper wall a substantially parallelogram shape similar—if not identical to—the shape of the main section lower wall.

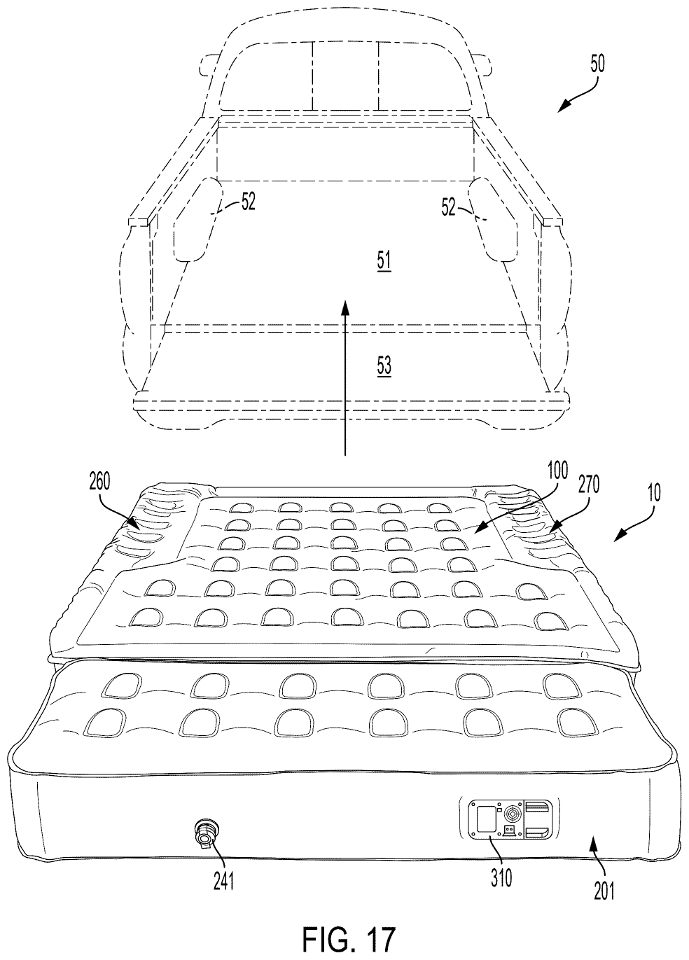

In certain embodiments, such as shown in FIG. 3 through FIG. 5, the first main lower side edge (113) may include a first main lower side edge lateral recess (115) while the second main lower side edge (114) may include a second main lower side edge lateral recess (116). Similarly, the first main upper side edge (123) may include a first main upper side edge lateral recess (125) while the second main upper side edge (124) may include a second main upper side edge lateral recess (126). These lateral recesses may be configured to fit around all or a portion of a wheel well ((52) as shown in FIG. 17) in a pickup truck bed ((51) as shown in FIG. 17) of a pickup truck ((50) as shown in FIG. 17) in those embodiments where the inflatable mattress ((10) as shown in FIG. 1) is configured for installation into the pickup truck bed.

As shown in FIG. 3 through FIG. 5, the at least one main section side wall (130) connects between the main section lower wall edges and the main section upper wall edges to form a main section air chamber ((150) as shown in FIG. 5). While FIG. 3 illustrates a single main section side wall extending around the entire perimeter of the main section, other embodiments may exist. For example, each combination of opposing main section upper wall edge and main section lower wall edge may include a single side wall spanning the length of said opposing edges and connected to one another at the ends thereof.

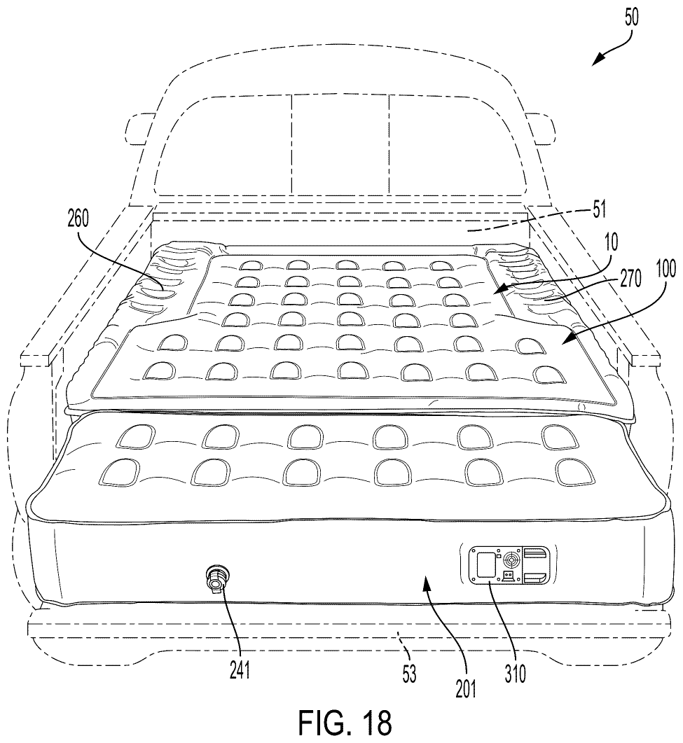

FIG. 3 and FIG. 4 also illustrate the main section (100) including a main section port (140). When present, the main section port may be located in the main section side wall (130). While the main section port may be located in any position along the main section side wall, in preferred embodiments the main section port will be located in the main section side wall in a location corresponding to the rear of the inflatable mattress (10) when installed in a pickup truck bed ((51) as shown in FIG. 17 and FIG. 18).

When present, the main section port (140) allows for the selective passage of air in and out of at least the main section (100) of the inflatable mattress (10). For example, a main valve (141) may selectively seal the main section port to allow a user to selectively deflate or inflate the inflatable mattress. The main valve may be a Boston-type valve or similar suitable user-adjustable fluid valve. In some embodiments, a cap may be provided for covering the main valve and preventing accidental leakage of air through the main section port and the main valve.

FIG. 3 and FIG. 4 further illustrate a primary electric air pump (300). When present, the primary electric air pump will be fluidly connected to the main section air chamber (150) to allow a user to inflate at least the main section (100) of the inflatable mattress (10). In certain embodiments, the primary electric air pump may also be fluidly connected to one or more—including all—of the secondary air chambers (250, 263, 273) of the minor sections (200, 201, 260, 270) to allow a user to inflate at least one of the minor sections of the inflatable mattress. Inflation of the minor section(s) using the primary electric air pump may occur simultaneously with, or separate from, inflation of the main section. The primary electric air pump may be any portable air pump, and may be powered by the vehicle's battery, a separate portable battery, an outdoor 110-volt or 220-volt AC power supply, or by other suitable power source. In some embodiments, the primary electric air pump (300) may be configured to fit within a main sidewall cavity (135) formed in a main section side wall (130). Also fitting within the main sidewall cavity (or a second main sidewall cavity in some embodiments) may be a battery pack. When present, the battery pack may provide a source of electricity for powering the primary electric air pump and/or the minor electric air pump (310).

FIG. 5 also illustrates the main section (100) including a plurality of main section collapsible columns (160). When present, the main section collapsible columns may be disposed within the main section of the inflatable mattress (10). Each main collapsible column will have an upper end and a lower end with the upper end being sealed to an inner surface of the main section upper wall (120) and the lower end being sealed to an inner surface of the main section lower wall (110).

When present, the main section collapsible columns (160) may be in the form of covered springs, air cylinders, inflatable cylinders, plastic coils, or other suitable deformable supports. Horizontally-oriented surface rings may be formed where the main section collapsible columns are sealed to the main section upper wall (120) and/or the main section lower wall (110) respectively.

In some embodiments, the main section collapsible columns (160) may be in the form of vertically-oriented collapsible interior loops. Each interior loop may be constructed of the same or similar material as the main section lower wall (110), main section upper wall (120), and/or main section side wall (130). As with other embodiments of the main section collapsible columns, horizontally-oriented surface rings may be formed where the main section collapsible columns are sealed to the main section upper wall and/or the main section lower wall respectively.

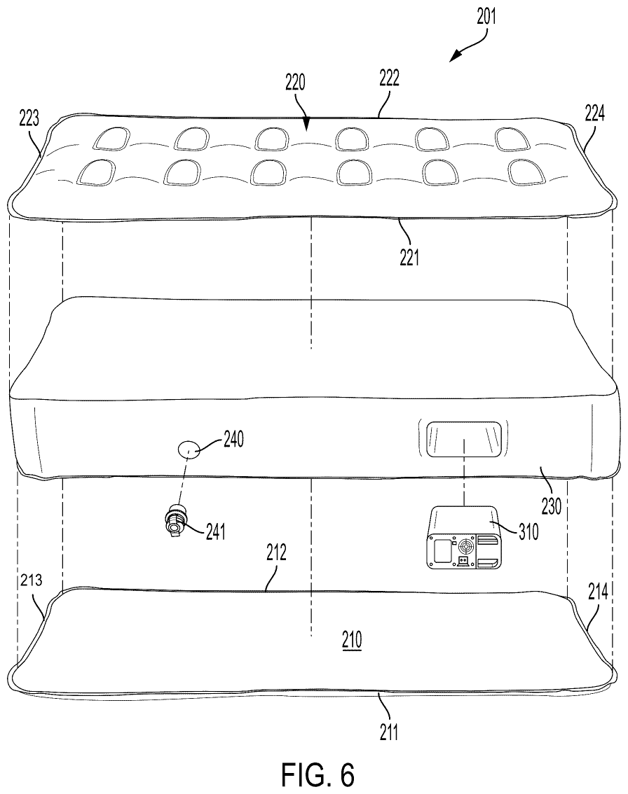

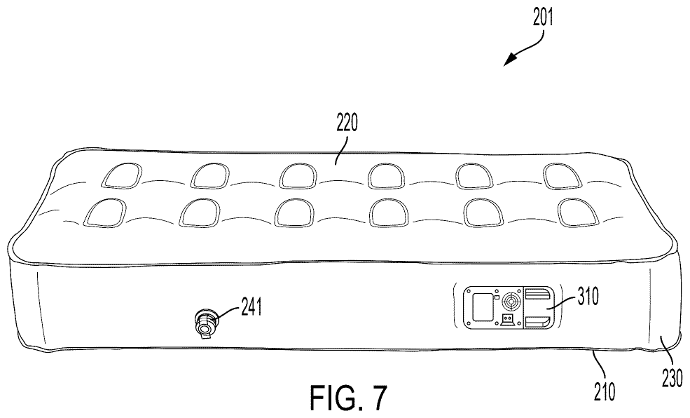

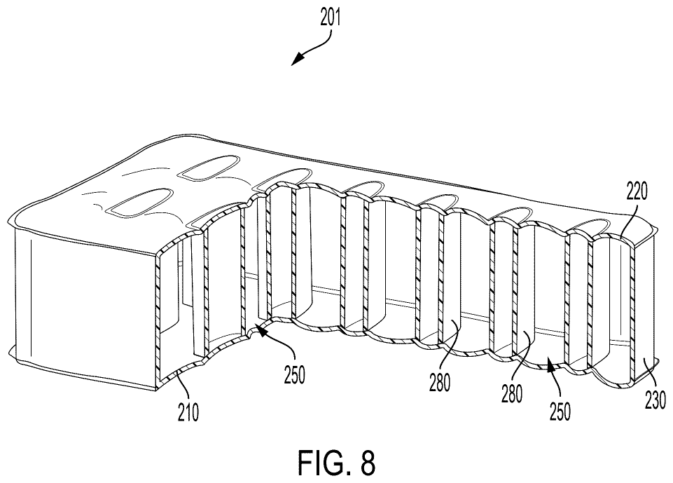

FIG. 6 through FIG. 8 illustrate various views of an embodiment of a minor section (200) of an inflatable mattress ((10) as shown in FIG. 1) which in this case is the secondary section (201) as illustrated in FIG. 1. FIG. 6 showing the secondary section in exploded form. FIG. 7 showing the secondary section in assembled form. FIG. 8 showing a cut away view of the secondary section.

As shown in FIG. 6, the secondary section lower wall (210) may include at least a first secondary lower end edge (211) and a second secondary lower end edge (212) opposite the first secondary lower end edge. Extending between opposing end points of the first secondary lower end edge and the second secondary lower end edge may be a first secondary lower side edge (213). Opposite the first secondary lower side edge may be a second secondary lower side edge (214). This configuration gives the secondary section a substantially parallelogram shape.

FIG. 6 further illustrates the secondary section upper wall (220) which may include at least a first secondary upper end edge (221) and a second secondary upper end edge (222) opposite the first secondary upper end edge. Extending between opposing end points of the first secondary upper end edge and the second secondary upper end edge may be a first secondary upper side edge (223). Opposite the first secondary upper side edge may be a second secondary upper side edge (224). This configuration gives the secondary section upper wall a substantially parallelogram shape similar—if not identical to—the shape of the secondary section lower wall.

As shown in FIG. 6 through FIG. 8, the at least one secondary section side wall (230)—when present—may connect between the secondary section lower wall edges and the secondary section upper wall edges to form a secondary air chamber ((250) as shown in FIG. 8). While FIG. 6 illustrates a single secondary section side wall extending around the entire perimeter of the secondary section, other embodiments may exist. For example, each combination of opposing secondary section upper wall edge and secondary section lower wall edge may include a single side wall spanning the length of said opposing edges and connected to one another at the ends thereof.

FIG. 6 and FIG. 7 also illustrate the secondary section (201) including a minor section port (240). When present, the minor section port may be located in the secondary section side wall (230). While the minor section port may be located in any position along the secondary section side wall, in preferred embodiments the minor section port will be located in the secondary section side wall in a location corresponding to the rear of the inflatable mattress (10) when installed in a pickup truck bed ((51) as shown in FIG. 17 and FIG. 18).

When present, the minor section port (240) allows for the selective passage of air in and out of the secondary section (201) of the inflatable mattress (10). For example, a minor valve (241) may selectively seal the minor section port to allow a user to selectively deflate or inflate the secondary section. The minor valve may be a Boston-type valve or similar suitable user-adjustable fluid valve. In some embodiments, a cap may be provided for covering the minor valve and preventing accidental leakage of air through the minor section port and the minor valve.

FIG. 6 and FIG. 7 further illustrate a minor electric air pump (310). When present, the minor electric air pump will be fluidly connected to one or more—including all—of the secondary air chamber (250, 263, 273) to allow a user to inflate at least one of the minor sections (201, 260, 270) of the inflatable mattress (10). The minor electric air pump may be any portable air pump, and may be powered by the vehicle's battery, a separate portable battery, an outdoor 110-volt or 220-volt AC power supply, or by other suitable power source. Alternatively, secondary air chamber (250) of the secondary section (201) may include an airflow aperture which allows for fluid connection to the main section air chamber (150) of the main section (100) such that the secondary air chamber of the secondary section may be inflated by air from the main section air chamber—such as that provided by the primary electric air pump (300) or through the main section port (140).

FIG. 8 also illustrates the secondary section (201) including a plurality of minor collapsible columns (280). When present, the minor collapsible columns may be disposed within the secondary section of the inflatable mattress (10). Each minor collapsible column will have an upper end and a lower end with the upper end being sealed to an inner surface of the secondary section upper wall (220) and the lower end being sealed to an inner surface of the secondary section lower wall (210).

When present, the secondary section collapsible columns (280) may be in the form of covered springs, air cylinders, inflatable cylinders, plastic coils, or other suitable deformable supports. Horizontally-oriented surface rings may be formed where the secondary section collapsible columns are sealed to the secondary section upper wall (220) and/or the secondary section lower wall (210) respectively.

In some embodiments, the secondary section collapsible columns (280) may be in the form of vertically-oriented collapsible interior loops. Each interior loop may be constructed of the same or similar material as the secondary section lower wall (210), secondary section upper wall (220), and/or (optional) secondary section side wall (230). As with other embodiments of the secondary section collapsible columns, horizontally-oriented surface rings may be formed where the secondary section collapsible columns are sealed to the secondary section upper wall and/or the secondary section lower wall respectively.

At least one minor section (200) will be connected to the main section (100) in a pivotable manner. The pivotable connection may be a first pivotable connection between one main section lower wall edge of the main section lower wall edges (111, 112, 113, 114) and one secondary section lower wall edge of the secondary section lower wall edges. Alternatively, the pivotable connection may be a second pivotable connection between one main section upper wall edge of the main section upper wall edges (121, 122, 123, 124) and one secondary section upper wall edge of the secondary section upper wall edges. The pivotable connection may be formed by joining the respective edges to one another, such as by sewing, by way of adhesive, by melt bonding, by a strip of material sewed, adhered to, or melt bonded to the two edges, or combinations thereof. In some embodiments, the pivotable connection may include a removable connection such as that formed by a zipper or similar fastener connecting the minor section to the main section.

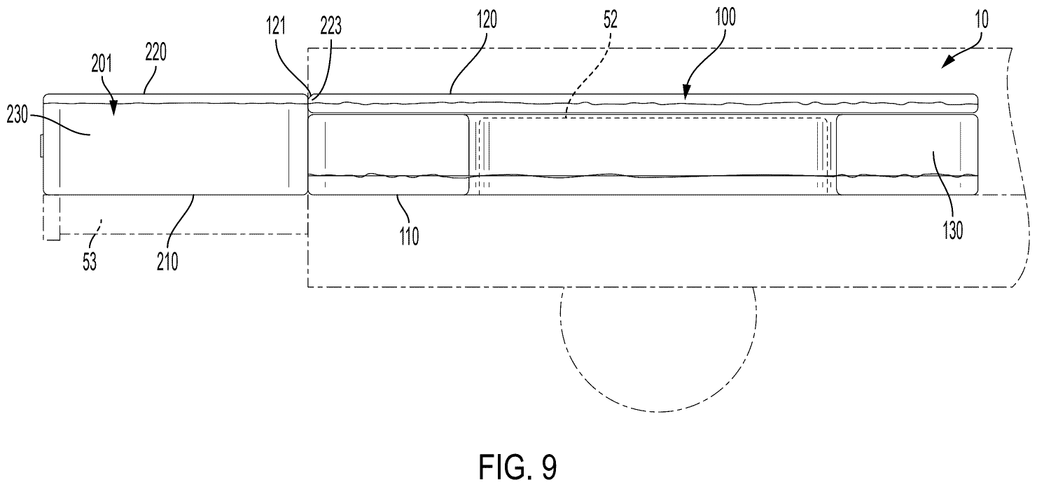

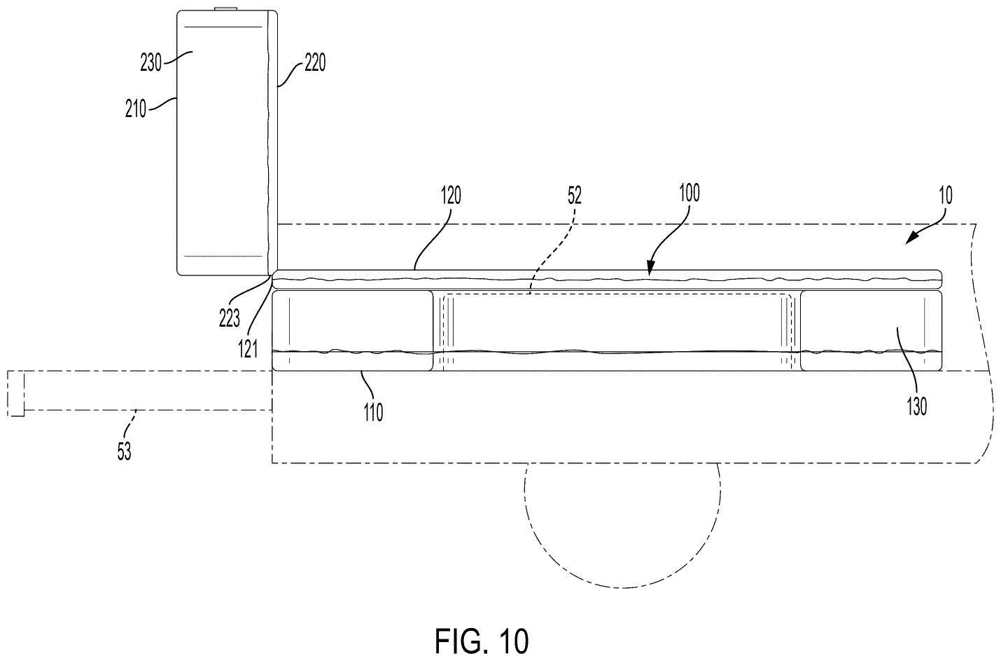

For example, FIGS. 9 and 10 illustrate an exemplary embodiment of a pivotable connection between the main section (100) and the secondary section (201). In this embodiment, the connection is between the first main upper end edge (121) and the second secondary upper end edge (222). FIG. 9 shows the main section and the secondary section in a first position in which the secondary section is flat with the secondary section side wall (230) abutting against the main section side wall (130). FIG. 10 shows the secondary section pivoted upward about the connection with the main side wall such that the main section upper wall (120) and the secondary section upper wall (220) form an angle of approximately 90°. In some embodiments, the pivotable connection between the main section and the secondary section may be such that the secondary section is capable of pivoting 180° about the connection point so that the secondary section upper wall is parallel with and abuts against a portion of the main section upper wall.

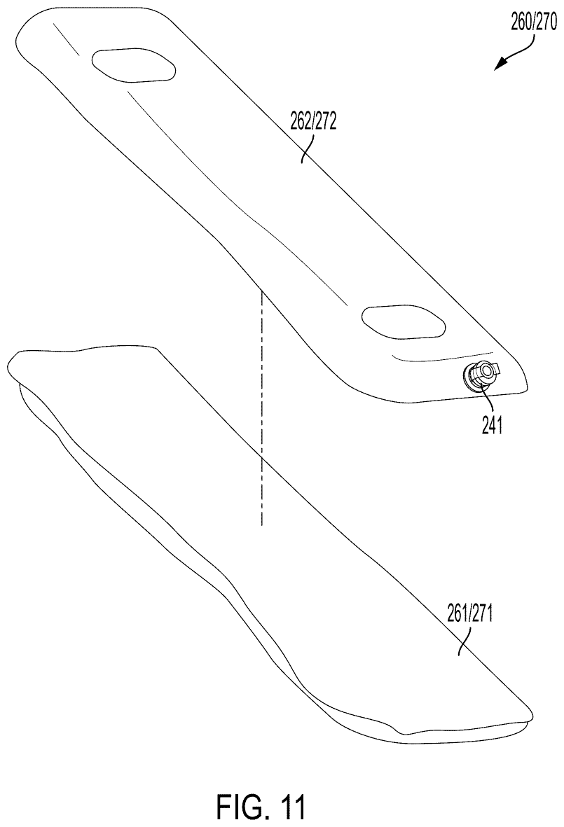

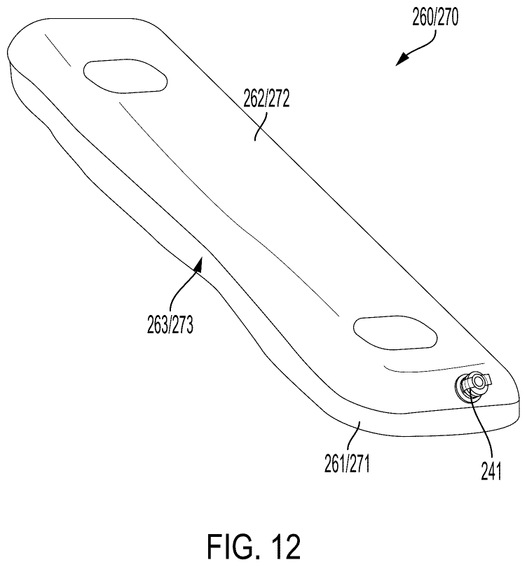

FIG. 11 and FIG. 12 illustrate various views of an embodiment of a minor section (200) of an inflatable mattress ((10) as shown in FIG. 1) which in this case may be either the tertiary section (260) or the quaternary section (270) as illustrated in FIG. 1. FIG. 11 showing the tertiary/quaternary section in exploded form. FIG. 12 showing the tertiary/quaternary section in assembled form.

As shown in FIG. 11, the tertiary section (260) may include a tertiary section lower wall (261) having tertiary section lower wall edges while the quaternary section (270) may include a quaternary section lower wall (271) having quaternary section lower wall edges. Similarly, the tertiary section may include a tertiary section upper wall (262) having tertiary section upper wall edges while the quaternary section may include a quaternary section upper wall (272) having quaternary section upper wall edges.

As shown in FIG. 12, the tertiary section lower wall (261) and the tertiary section upper wall (262) connect to one another to form a second secondary air chamber (263). Similarly, the quaternary section lower wall (271) and the quaternary section upper wall (272) connect to one another to form a third secondary air chamber (273).

FIG. 11 and FIG. 12 also illustrate the tertiary section (260) and/or the quaternary section (270) including a minor section port. When present, the minor section port may be located in any position in either of the upper or lower wall of the respective minor section.

When present, the minor section port (240) allows for the selective passage of air in and out of the tertiary section (260) and/or the quaternary section (270) of the inflatable mattress (10). For example, a minor valve (241) may selectively seal the minor section port to allow a user to selectively deflate or inflate the respective minor section. The minor valve may be a Boston-type valve or similar suitable user-adjustable fluid valve. In some embodiments, a cap may be provided for covering the minor valve and preventing accidental leakage of air through the minor section port and the minor valve.

In some embodiments, one or both of the second secondary air chamber (263) and/or the third secondary air chamber (273) may be fluidly connected to the primary electric air pump (300) and/or the minor electric air pump (310). This allows a user to inflate at least one of the minor sections (260, 270) of the inflatable mattress (10). Alternatively, one or both of the second secondary air chamber and/or the third secondary air chamber may include an airflow aperture which allows for fluid connection to the main section air chamber (150) of the main section (100) such that the second secondary air chamber and/or the third secondary air chamber may be inflated by air from the main section air chamber—such as that provided by the primary electric air pump or through the main section port (140).

At least one of the tertiary section (260) and or the quaternary section (270) will be connected to the main section (100) in a pivotable manner. For the tertiary section, the pivotable connection may be a third pivotable connection between one tertiary section lower wall edge of the tertiary section lower wall edges and at least a portion of the first main upper side edge lateral recess (125). For the quaternary section, the pivotable connection may be a fourth pivotable connection between one quaternary section lower wall edge of the quaternary section lower wall edges and at least a portion of the second main upper side edge lateral recess (126). The pivotable connections may be formed by joining the respective edges to one another, such as by sewing, by way of adhesive, by melt bonding, by a strip of material sewed, adhered to, or melt bonded to the two edges, or combinations thereof. In some embodiments, the third pivotable connection and/or the fourth pivotable connection may include a removable connection such as that formed by a zipper or similar fastener connecting the tertiary section and/or the quaternary section to the main section.

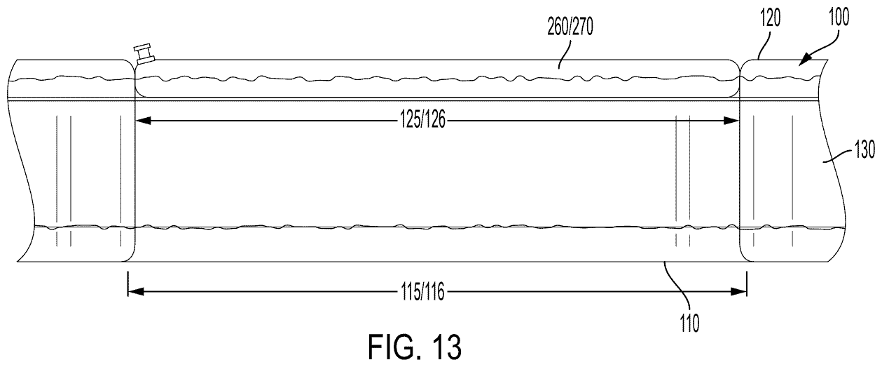

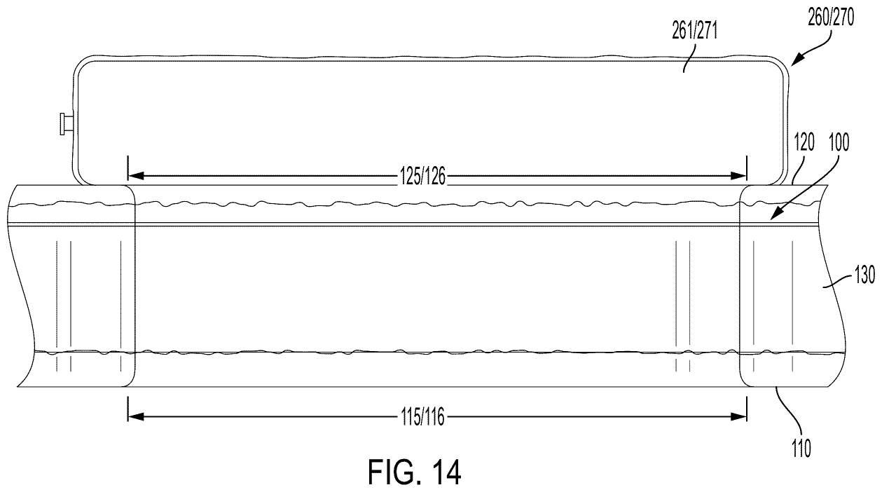

For example, FIGS. 13 and 14 illustrate an exemplary embodiment of a pivotable connection between the main section (100) and the tertiary section (260) or quaternary section (270). FIG. 13 shows the main section and the tertiary section or quaternary section in a first position in which the tertiary section or quaternary section is flat with the respective tertiary section upper wall (262) or quaternary section upper wall (273) substantially parallel with the main section upper wall (120). FIG. 14 shows the tertiary section or quaternary section pivoted upward about the connection with the main section such that the main section upper wall and the tertiary section upper wall or quaternary section upper wall form an angle of approximately 90°. In some embodiments, the pivotable connection between the main section and the tertiary section and/or quaternary section may be such that the tertiary section and/or the quaternary section is capable of pivoting 180° about the connection point so that the tertiary and/or quaternary section upper wall is parallel with and abuts against a portion of the main section upper wall.

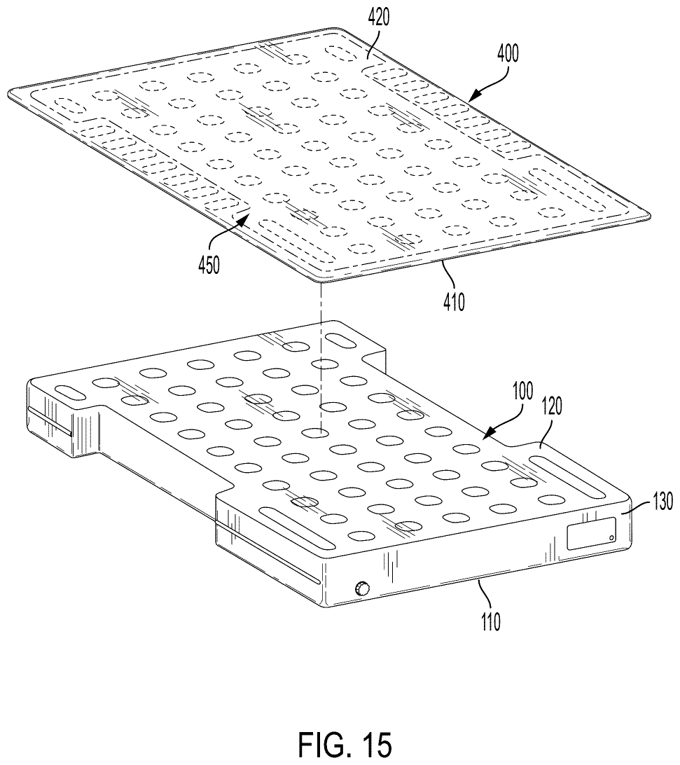

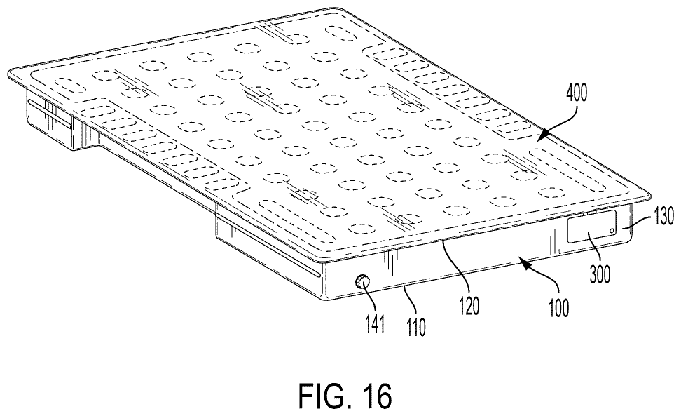

In some embodiments of the inflatable mattress (10), the main section (100) may include a mattress topper (400) as shown in FIG. 15 and FIG. 16. When present, the mattress topper will include a mattress topper lower wall (410) having mattress topper lower wall edges and a mattress topper upper wall (420) having mattress topper upper wall edges. Preferably, the mattress topper lower wall and mattress topper upper wall will be sized and shaped in accordance with the main section lower wall (110) and the main section upper wall (120). Although in certain embodiments, the mattress topper lower wall and mattress topper upper wall may not include lateral recesses such as those found in the main section lower wall and main section upper wall. The mattress topper lower wall and the mattress topper upper wall will be connected to one another to form a mattress topper air chamber (450). When assembled as shown in FIG. 16, at least a portion of an outer surface of the mattress topper lower wall (410) will abut against an outer surface of the main section upper wall (120).

In certain embodiments, the mattress topper (400) may include a mattress topper port (not shown). When present, the mattress topper port may be located in any position in either of the mattress topper lower wall (410) or the mattress topper lower wall (420). The mattress topper port allows for the selective passage of air in and out of the mattress topper. For example, an air valve may selectively seal the mattress topper port to allow a user to selectively deflate or inflate the mattress topper. The air valve may be a Boston-type valve or similar suitable user-adjustable fluid valve. In some embodiments, a cap may be provided for covering the air valve and preventing accidental leakage of air through the mattress topper port and the air valve.

In some embodiments, the mattress topper air chamber (450) may be fluidly connected to the primary electric air pump (300) and/or the minor electric air pump (310). This allows a user to inflate mattress topper (400) of the inflatable mattress (10). Alternatively, the mattress topper air chamber may include an airflow aperture which allows for fluid connection to the main section air chamber (150), the secondary air chamber (250) of the secondary section (201), the second secondary air chamber (263), and/or the third secondary air chamber (273) such that the mattress topper air chamber may be inflated by air from one of the other air chambers—such as that provided by the primary electric air pump, the minor electric air pump, through the main section port (140), or through one of the minor section ports (240).

FIG. 17 and FIG. 18 illustrate an exemplary embodiment of an inflatable mattress disposed within a pickup truck bed (51) of a pickup truck (50). The pickup truck bed may include a pair of opposing wheel wells (52) and/or a tailgate (53). FIG. 17 illustrating the inflatable mattress exploded from the pickup truck bed, with FIG. 18 illustrating the inflatable mattress inserted into the pickup truck bed.

As shown in FIG. 17 and FIG. 18, the main section (100) is configured to dispose within the pickup truck bed (51) between the edges of the pickup truck bed. When the pickup truck bed includes a pair of opposing wheel wells, the main section will preferably include lateral recesses as described herein which are configured to fit around the opposing wheel wells allowing at least a portion of the outer surface of the main section lower wall to abut against at least a portion of the upwardly facing surface of the pickup truck bed.

In embodiments where the pickup truck bed (51) includes a tailgate (53), the secondary section (201) may be present. The secondary section is configured to dispose against the upwardly facing surface of the tailgate when the tailgate is in a lowered—or opened—position as shown in FIG. 17 and FIG. 18. When the tailgate is pivoted to a raised- or closed-position, the pivotable connection between the secondary section and the main section allows the secondary section to pivot as well so that the secondary section may be disposed within the confines of the pickup truck bed such as for storage and transportation.

In embodiments where the pickup truck bed (51) includes a pair of opposing wheel wells (52), one or both of the tertiary section (260) and/or the quaternary section (270) may be present. The tertiary section is configured to dispose against the upwardly facing surface of one of the two wheel wells, while the quaternary section is configured to dispose against the upwardly facing surface of the second of the two wheel wells as shown in FIG. 17 and FIG. 18. The pivotable connection between the tertiary section and the main section and/or the quaternary section and the main section allows for the tertiary section and/or the quaternary section to pivot relative to the main section to allow for an improved fitment within different pickup truck beds having wheel wells of different heights.

The various walls of the main section (100) and the minor section(s) (200) may be made of a vinyl material, nylon, or other suitable pliable durable plastic materials for forming an inflatable bladder. These walls may be joined to one another by way of an adhesive, a polymer weld, sewing, or combinations thereof which result in an air-tight seal between the walls.

The embodiments of an inflatable mattress disclosed herein address many of the issues associated with inflatable mattresses adapted for use in pickup truck beds. The tertiary and quaternary sections—with their pivotable connection to the main section—allow the inflatable mattress to cover a wider variety of pickup truck beds having different sized wheel wells without flexing or bending the main section of the inflatable mattress into a “U” or “V” shape that is uncomfortable for the user. In addition, the secondary section—with its pivotable connection to the main section—allows the inflatable mattress to be selectively extended into the opened section of the tailgate while still allowing the tailgate to be selectively closed during vehicle operation and without the possibility that the tailgate section of the inflatable mattress may become dislodged from the main section of the inflatable mattress during use.

While the inflatable mattress has been described as having one or more exemplary designs, the present article may be further modified within the spirit and scope of this disclosure. This application is therefore intended to cover any variations, uses, or adaptations of the inflatable mattress using its general principles.

What is claimed is:

1. An inflatable mattress (10) comprising:
a main section (100) having a main section lower wall (110) having main section lower wall edges, a main section upper wall (120) having main section upper wall edges, and at least one main section side wall (130) connecting between the main section lower wall edges and the main section upper wall edges, said main section lower wall, main section upper wall, and at least one main section side wall forming a main section air chamber (150);
at least one minor section (200) having a minor section lower wall having minor section lower wall edges, and a minor section upper wall having minor section upper wall edges, said minor section lower wall and said minor section upper wall connected to one another and forming a minor air chamber;
wherein the at least one minor section is connected to the main section by:
a first pivotable connection between one main section lower wall edge of the main section lower wall edges and one minor section lower wall edge of the minor section lower wall edges, or between one main section upper wall edge of the main section upper wall edges and one minor section upper wall edge of the minor section upper wall edges.

2. The inflatable mattress of claim 1, further comprising a primary electric air pump (300) fluidly connected to the main section air chamber.

3. The inflatable mattress of claim 2, wherein the at least one main section side wall comprises a main sidewall cavity (135), and the primary electric air pump is configured to fit within the main sidewall cavity.

4. The inflatable mattress of claim 2, wherein the primary electric air pump is fluidly connected to the minor air chamber of at least one minor section.

5. The inflatable mattress of claim 1, further comprising a minor electric air pump (310) fluidly connected to the minor air chamber of at least one minor section.

6. The inflatable mattress of claim 1, wherein:
the main section lower wall edges include a first main lower end edge (111), a second main lower end edge (112) opposite the first main lower end edge, a first main lower side edge (113) extending between the first main lower end edge and the second main lower end edge, and a second main lower side edge (114) opposite the first main lower side edge;
the main section upper wall edges include a first main upper end edge (121), a second main upper end edge (122) opposite the first main upper end edge, a first main upper side edge (123) extending between the first main upper end edge and the second main upper end edge, and a second main upper side edge (124) opposite the first main upper side edge;
the at least one minor section comprises a secondary section (201) having:
secondary section lower wall edges including a first secondary lower end edge (211), a second secondary lower end edge (212) opposite the first secondary lower end edge, a first secondary lower side edge (213) extending between the first secondary lower end edge and the second secondary lower end edge, and a second secondary lower side edge (214) opposite the first secondary lower side edge;
secondary section upper wall edges including a first secondary upper end edge (221), a second secondary upper end edge (222) opposite the first secondary upper end edge, a first secondary upper side edge (223) extending between the first secondary upper end edge and the second secondary upper end edge, and a second secondary upper side edge (224) opposite the first secondary upper side edge; and
wherein the secondary section is connected to the main section by:
the first pivotable connection being between the first main lower end edge and the second secondary lower end edge, or between the first main upper end edge and the second secondary upper end edge.

7. The inflatable mattress of claim 6, wherein the secondary section includes at least one secondary section side wall (230) connecting the first secondary section lower wall edges and the first secondary section upper wall edges.

8. The inflatable mattress of claim 6, wherein:
the first main lower side edge includes a first main lower side edge lateral recess (115);
the second main lower side edge includes a second main lower side edge lateral recess (116);
the first main upper side edge includes a first main upper side edge lateral recess (125);
the second main upper side edge includes a second main upper side edge lateral recess (126); and
the at least one minor section includes:
a tertiary section (260) having a tertiary section lower wall (261) having tertiary section lower wall edges, and a tertiary section upper wall (262) having tertiary section upper wall edges, said tertiary section lower wall and said tertiary section upper wall connected to one another and forming a second secondary air chamber (263); and
a quaternary section (270) having a quaternary section lower wall (271) having quaternary section lower wall edges, and a quaternary section upper wall (272) having quaternary section upper wall edges, said quaternary section lower wall and said quaternary section upper wall connected to one another and forming a third secondary air chamber (273); and
wherein the tertiary section is connected to the main section by a second pivotable connection between one tertiary section lower wall edge of the tertiary section lower wall edges and at least a portion of the first main upper side edge lateral recess; and
wherein the quaternary section is connected to the main section by a third pivotable connection between one quaternary section lower wall edge of the quaternary section lower wall edges and at least a portion of the second main upper side edge lateral recess.

9. The inflatable mattress of claim 6, wherein the secondary section further comprises a plurality of minor collapsible columns (280), each minor collapsible column of the plurality of minor collapsible columns being located between and connected to the secondary section lower wall and the secondary section upper wall.

10. The inflatable mattress of claim 1, wherein:
the main section lower wall edges include a first main lower end edge (111), a second main lower end edge (112) opposite the first main lower end edge, a first main lower side edge (113) extending between the first main lower end edge and the second main lower end edge and having a first main lower side edge lateral recess (115), and a second main lower side edge (114) opposite the first main lower side edge and having a second main lower side edge lateral recess (116);
the main section upper wall edges include a first main upper end edge (121), a second main upper end edge (122) opposite the first main upper end edge, a first main upper side edge (123) extending between the first main upper end edge and the second main upper end edge and having a first main upper side edge lateral recess (125), and a second main upper side edge (124) opposite the first main upper side edge and having a second main upper side edge lateral recess (126); and
the at least one minor section includes:
a tertiary section (260) having a tertiary section lower wall (261) having tertiary section lower wall edges, and a tertiary section upper wall (262) having tertiary section upper wall edges, said tertiary section lower wall and said tertiary section upper wall connected to one another and forming a second secondary air chamber (263); and
a quaternary section (270) having a quaternary section lower wall (271) having quaternary section lower wall edges, and a quaternary section upper wall (272) having quaternary section upper wall edges, said quaternary section lower wall and said quaternary section upper wall connected to one another and forming a third secondary air chamber (273); and
wherein the tertiary section is connected to the main section by a second pivotable connection between one tertiary section lower wall edge of the tertiary section lower wall edges and at least a portion of the first main upper side edge lateral recess; and
wherein the quaternary section is connected to the main section by a third pivotable connection between one quaternary section lower wall edge of the quaternary section lower wall edges and at least a portion of the second main upper side edge lateral recess.

11. The inflatable mattress of claim 1, wherein the main section comprises a main section port (140) located in the main section side wall with a main valve (141) fluidly connected to the main section port.

12. The inflatable mattress of claim 1, wherein each minor section of the at least one minor section comprises a minor section port (240) with a minor valve (241) fluidly connected to the minor section port.

13. The inflatable mattress of claim 1, wherein the main section further comprises a plurality of main collapsible columns (160), each main collapsible column of the plurality of main collapsible columns being located between and connected to the main section lower wall and the main section upper wall.

14. The inflatable mattress of claim 1, wherein the main section further comprises a mattress topper (400) having a mattress topper lower wall (410) having mattress topper lower wall edges, and a mattress topper upper wall (420) having mattress topper upper wall edges, said mattress topper lower wall and said mattress topper upper wall connected to one another and forming a mattress topper air chamber (450).

15. The inflatable mattress of claim 1, wherein the at least one minor section is configured to rest upon a tailgate of a pickup truck when the tailgate is in an open position.

16. The inflatable mattress of claim 1, wherein the at least one minor section is selectively inflatable and deflatable independent of the main section.

17. The inflatable mattress of claim 7, wherein:
the first main lower side edge includes a first main lower side edge lateral recess (115);
the second main lower side edge includes a second main lower side edge lateral recess (116);
the first main upper side edge includes a first main upper side edge lateral recess (125);
the second main upper side edge includes a second main upper side edge lateral recess (126); and
the at least one minor section includes:
a tertiary section (260) having a tertiary section lower wall (261) having tertiary section lower wall edges, and a tertiary section upper wall (262) having tertiary section upper wall edges, said tertiary section lower wall and said tertiary section upper wall connected to one another and forming a second secondary air chamber (263); and
a quaternary section (270) having a quaternary section lower wall (271) having quaternary section lower wall edges, and a quaternary section upper wall (272) having quaternary section upper wall edges, said quaternary section lower wall and said quaternary section upper wall connected to one another and forming a third secondary air chamber (273); and
wherein the tertiary section is connected to the main section by a second pivotable connection between one tertiary section lower wall edge of the tertiary section lower wall edges and at least a portion of the first main upper side edge lateral recess; and
wherein the quaternary section is connected to the main section by a third pivotable connection between one quaternary section lower wall edge of the quaternary section lower wall edges and at least a portion of the second main upper side edge lateral recess.

18. The inflatable mattress of claim 7, wherein the secondary section further comprises a plurality of minor collapsible columns (280), each minor collapsible column of the plurality of minor collapsible columns being located between and connected to the secondary section lower wall and the secondary section upper wall.

19. The inflatable mattress of claim 15, wherein the at least one minor section is configured to pivot into a stowed position within a bed of the pickup truck to allow the tailgate to be closed without removal or deflation of the inflatable mattress.

20. The inflatable mattress of claim 17, wherein the secondary section further comprises a plurality of minor collapsible columns (280), each minor collapsible column of the plurality of minor collapsible columns being located between and connected to the secondary section lower wall and the secondary section upper wall.
